(19) United States
(12) Patent Application Publication
(10) Pub. No.: US 2012/0330665 A1
(43) Pub. Date: Dec. 27, 2012

(54) PRESCRIPTION LABEL READER

(75) Inventor: Kenneth Berkun, Kailua, HI (US)

(73) Assignee: Labels That Talk, LTD, Redmond, WA (US)

(21) Appl. No.: 13/488,385

(22) Filed: Jun. 4, 2012

Related U.S. Application Data
(60) Provisional application No. 61/492,915, filed on Jun. 3, 2011.

(51) Int. Cl. G10L 13/08; G06K 19/06

(52) U.S. Cl. 704/260; 235/494; 704/E13.011

(57) ABSTRACT

A system is configured to read a prescription label and output audio information corresponding to prescription information present on or linked to the prescription label. The system may have knowledge about prescription labels and prescription information, and use this knowledge to present the audio information in a structured form to the user.

### CROSS REFERENCE TO RELATED APPLICATIONS

The present application claims priority benefit under 35 USC §119(e) to U.S. Provisional Application Ser. No. 61/492,915; entitled “PRESCRIPTION BOTTLE READER”, invented by Kenneth Berkun; filed on Jun. 3, 2011; which is co-pending herewith at the time of filing, and which, to the extent not inconsistent with the disclosure herein, is incorporated by reference.

### BACKGROUND

Prescription labels may be difficult for some users to read and/or understand. This can especially be a problem among older populations most likely to be in need of several prescription medications on an ongoing basis.

What is needed is a system that can convert information from a prescription label into useful information that is understandable by a user. Preferably, such a system would present the information in a form that is friendly and accessible to a user, such as using audio output corresponding to or resembling a human voice.

### SUMMARY

A system is configured to read a prescription label, and output audio information corresponding to prescription information present on or linked to the prescription label. The system may have knowledge about prescription labels and prescription information, and use this knowledge to present the audio information in a structured form to the user.

Methods and apparatuses are disclosed for performing optical scanning of prescription labels, parsing information from each prescription label into prescription information fields, and outputting an audio representation of at least a portion of one or more fields.

According to an embodiment, a system for reading prescription labels may include an image capture device configured to capture an image of a prescription label carrying prescription information. A microprocessor circuit operatively coupled to the image capture device may be configured to process data corresponding to the image, cause transmission of data corresponding to the image, or process the data corresponding to the image and cause transmission of the data corresponding to the image to convert the image into speech corresponding to the prescription information. An audio output device operatively coupled to the microprocessor circuit may be configured to output the speech corresponding to the prescription information to a user as an audible message. The image capture device, microprocessor circuit, and audio output device may form portions of a smart phone, tablet computer, portable computer, or desktop computer, for example. Application software running on the client or user device may provide the described functionality. Conversion of the prescription information to speech may include image processing, prescription information parsing, and prescription information-to-speech conversion. Optionally, conversion of the prescription information to speech may include decoding and output of a bar code symbol carrying the prescription information and/or an audio recording of the speech corresponding to the prescription information. The conversion of the prescription information to speech may occur on a user or client device, on a server (remote resource), or using a combination of client and server processing.

According to an embodiment, a method for providing prescription information to a user may include receiving data corresponding to an image of a prescription label, performing image processing on the data corresponding to the image of the prescription label to produce prescription information including one or more fields, converting at least one field of prescription information into corresponding audio information, and outputting the audio information for playback to a user.

According to another embodiment, a system for reading prescription labels includes an image capture device configured to capture the image of a prescription label, a microprocessor operatively coupled to the image capture device, a computer memory operatively coupled to the image capture device and the microprocessor, and an audio output device operatively coupled to the microprocessor and computer memory. The system may be configured to cooperate to convert the image of the prescription label to prescription information, parse the prescription information into fields, convert one or more fields into an audio file, and output the audio file as an audible signal to a user.

According to other embodiments, a method for providing prescription information includes capturing an image of a prescription label, performing optical character recognition on the captured image of the prescription label to produce prescription information, parsing prescription information into one or more fields, converting at least one field of prescription information into corresponding audio information, and playing the audio information to a user.

Because prescription bottle labels contain a large variety of information, it may be desirable for only the most relevant information (such as medicine name and dosage) to be presented to a user. According to embodiments, systems and methods may default to most relevant (highest priority) information to be output to a user via an audible speech message. Other, less relevant (lower priority) information (such as prescribing doctor name) may be output as speech upon receiving a command from the user.

### BRIEF DESCRIPTION OF THE FIGURES

FIG. 1 is a block diagram of a system for scanning a prescription label on a prescription bottle, and providing an audio representation of at least portions of the prescription label data to a user, according to an embodiment.

FIG. 2 is a block diagram of a system for scanning a prescription label on a prescription bottle, and providing an audio representation of at least portions of the prescription label data to a user, according to another embodiment.

FIG. 3 is a flow chart showing a method for scanning a prescription label and presenting an audio representation of at least portions of the prescription label data to a user, according to an embodiment.

FIG. 4 is a flow chart of a method for converting an image of a prescription label into an audio representation of at least some of the prescription information on the label and outputting the audio representation, according to an embodiment.

FIG. 5A is a diagram of an illustrative prescription label, according to an embodiment.

FIG. 5B is a graphical diagram of a prescription label format corresponding to the prescription label instance indicated by FIG. 5A, according to an embodiment.

FIG. 6A is a diagram of another illustrative prescription label, according to another embodiment.

FIG. 6B is a graphical diagram of a prescription label format corresponding to the prescription label instance indicated by FIG. 6A, according to another embodiment.

FIG. 7 is a state diagram showing a process for extracting and parsing prescription information from a prescription label, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

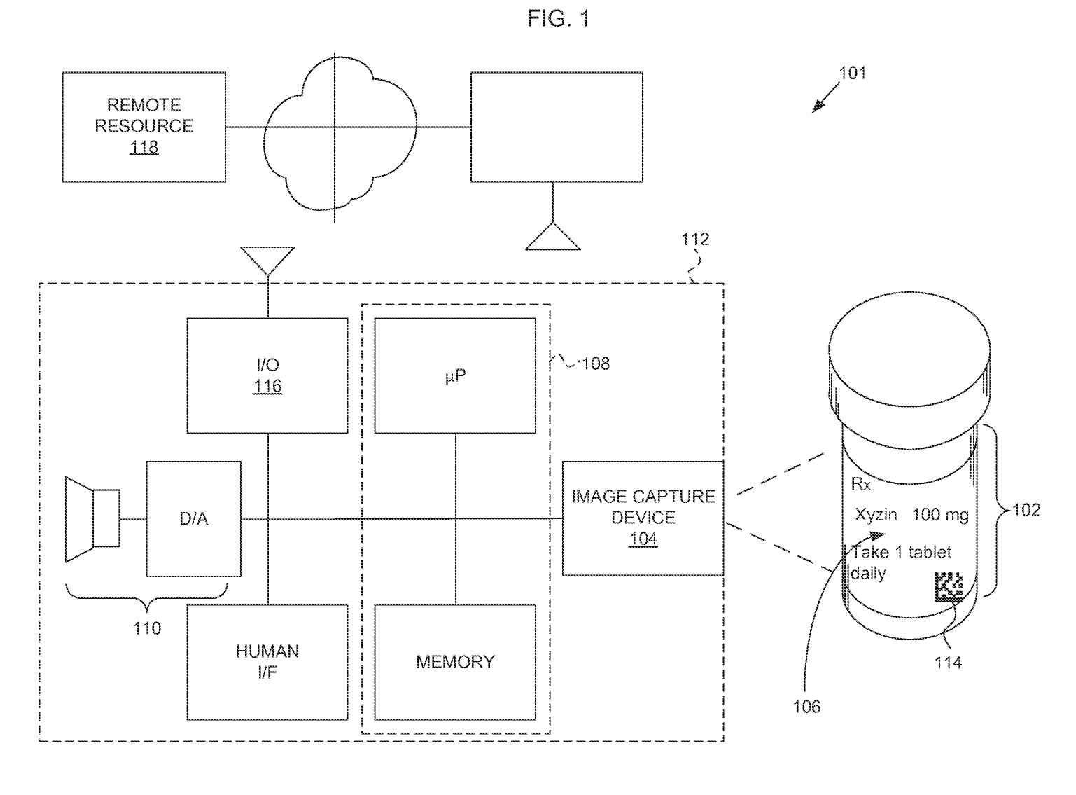

FIG. 1 is a block diagram of a system 101 for scanning a prescription label 102 and converting at least some of the information on label 102 into a speech message (pre-recorded or synthesized) for output to the user of the system 101. A client and/or stand-alone device 112 may include a microprocessor circuit 108, an image capture device 104 operatively coupled to the microprocessor circuit, and an audio output device 110. The image capture device 104 may be configured to capture an image of a prescription label 102 carrying prescription information 106. The image capture device 104 may, for example, include a digital camera or beam scanner configured to capture an image of all or part of the prescription label 102 including the prescription information 106. The microprocessor circuit 108 may be configured to process data corresponding to the image to convert the image into speech corresponding to the prescription information 106. The microprocessor circuit 108 may then cause the audio output device 110 to output the speech corresponding to the prescription information 106 to a user as an audible message.

Additionally or alternatively, the client or stand-alone device 112 may include a communication interface 116 operatively coupled to the microprocessor circuit 108. The microprocessor circuit 108 may cause transmission of data corresponding to the image, optionally after preprocessing, via the communication interface 116 for conversion of the image into speech corresponding to the prescription information 106 by a remote resource 118. The client device 112 may then receive a data file or streaming data from the remote resource 118, the data file or streaming data including speech data corresponding to the prescription information 106. The remote resource 118 may, for example, include one or more server computers.

Alternatively, the microprocessor circuit 108 may cause transmission of data corresponding to the image via the communication interface 116 to the remote resource 118 for preprocessing, then receive preprocessed data from the remote resource 118. The microprocessor circuit 108 may then convert the received preprocessed data into speech.

The client or stand-alone device 112 may take various forms such as, for example, a smart phone, tablet computer, portable computer, or desktop computer. The device 112 may alternatively be configured as a purpose-built prescription label reader.

The microprocessor circuit 108 may be configured to run a software application including computer executable instructions for processing the image and/or causing transmission of the data corresponding to the image to convert the image into speech corresponding to the prescription information 106.

Optionally, the microprocessor circuit 108 may be configured to receive video images or a sequence of still images of the prescription label 102 from the image capture device 104 while the user rotates a cylindrical prescription label 102, and to stitch the video images or sequence of still images into a two-dimensional image of the cylindrical prescription label 102. Optionally, the apparatus 112 may include a mechanical or optical encoder (not shown) configured to sense rotation corresponding to a cylindrical prescription label 102. Processing the image may include converting the cylindrical prescription label 102 image into a corresponding two-dimensional image responsive to data from the mechanical or optical encoder. Optionally, the image capture device 104 may include an apparatus to rotate a prescription bottle or an apparatus to scan around a stationary bottle. Optionally, the image capture device 104 may include an apparatus for receiving or presenting a blister pack of medication for image capture. Various medication packages are available and are contemplated to be imaged according to embodiments.

Converting the image into speech corresponding to the prescription information 106 may include synthesizing the speech corresponding to the prescription information 106. This may include, for example, decoding the image into text and converting the text to speech.

An image-to-speech system (or “engine”) may include front-end and back-end processing. The front-end processing may convert the image into raw data, then convert the raw data containing generic symbols and/or prescription-specific symbols into the equivalent of written-out words. As described below, the front-end processing may include parsing the raw data into one or more prescription messages, optionally including data not literally included on the prescription label 102. This process may be referred to as application-specific text normalization, pre-processing, and/or tokenization. The front-end processing may assign phonetic transcriptions to each word, and divide and mark the text into prosodic units like phrases, clauses, and sentences. Optionally, such prosodic unit division may be performed during other portions of the parsing process. The process of assigning phonetic transcriptions to words may be referred to as text-to-phoneme or grapheme-to-phoneme conversion.

Phonetic transcriptions and prosody information together make up the symbolic linguistic representation that is output by the front-end.

Back-end processing, which may be referred to as speech synthesis, may convert the symbolic linguistic representation into sound, such as an audio file or streaming audio. In some embodiments, back-end processing may include computing a target prosody (pitch contour, phoneme durations), which may be imposed on the output speech.

Conversion of the image to raw data may include performing optical character recognition (OCR), decoding a bar code symbol such as a linear, 2D stacked, or 2D matrix symbol and extracting prescription information carried in the human-readable text, or decoding a bar code symbol and extracting a prescription identifier encoded in the symbol and retrieving corresponding prescription information in a database or look-up table.

Alternatively, converting the image into speech corresponding to the prescription information may include playing back a recorded message corresponding to the prescription. For example, this may include converting the image to raw data, as described above, wherein the raw data includes a prescription identifier, and retrieving a corresponding recorded message from a database or look-up table. In another embodiment, the prescription label 102 may include a bar code symbol 114 carrying the speech corresponding to the prescription information. Outputting audible information to the user may then include playback of the speech retrieved from the bar code symbol 114. As describe elsewhere, a good symbology for carrying such speech is the Soundpaper™ symbology, available from Labels That Talk, Ltd. of Redmond, Wash. USA.

In an embodiment using a Soundpaper symbol, the encoded data may include a plurality of speech segments and the bar code symbol 114 may include a corresponding plurality of speech segment data fields. The microprocessor circuit 108 may be further configured to separately decode each speech segment data field and assemble a plurality of decoded speech segments into the decoded speech segment data.

As described above, the prescription label 102 may include a bar code symbol 114 carrying encoded data corresponding to prescription information 106. The microprocessor circuit 108 may be configured to decode the bar code symbol 114, parse the prescription information 106 into one or more data messages, convert the one or more data messages into one or more speech messages, and assemble the one or more speech messages into the speech corresponding to the prescription information 106. Parsing the prescription information 106 into one or more data messages may include parsing the prescription information 106 into a predetermined order according to importance, convenience, or user preferences, for example.

As described above, the prescription label 102 may include human-readable text corresponding to prescription information 106. The microprocessor circuit 108 may be configured to perform optical character recognition on the human-readable text to decode the prescription information 106, parse the prescription information 106 into one or more data messages, convert the one or more data messages into one or more speech messages, and assemble the one or more speech messages into the speech corresponding to the prescription information 106. As with the bar code prescription information embodiment, parsing the prescription information 106 into one or more data messages may include parsing the prescription information 106 into a predetermined order according to importance, convenience, or user preferences.

As indicated above, some or all of the processing associated with conversion of prescription information 106 into speech corresponding to the prescription information 106 may be performed by a remote resource 118 such as a server computer. The client device 112 may include a communication interface 116 operatively coupled to the microprocessor circuit 108.

According to an embodiment, the microprocessor circuit 108 may be configured to cause transmission of the image from the communication interface 116 to the remote resource 118 and to receive a data file or streaming data from the remote resource corresponding to the speech (corresponding to the prescription information 106) for output as an audible message.

According to another embodiment, the microprocessor circuit 108 may be configured to decode the image, cause transmission of decoded data corresponding to the image from the communication interface 116 to a remote resource 118, and to receive a data file or streaming data from the remote resource 118 corresponding to the speech (corresponding to the prescription information 106) for output as an audible message.

According to another embodiment, the prescription label 102 may include a bar code symbol 114 carrying an identifier corresponding to the prescription information 106. The microprocessor circuit 108 may be configured to cause transmission of the identifier to a remote resource 118, to receive information from the remote resource 118 corresponding to the prescription, and to convert the information corresponding to the prescription into the speech corresponding to the prescription. For example, an identifier corresponding to the prescription may include a prescription number.

Additionally or alternatively, the microprocessor circuit 108 may be configured to cause transmission of the identifier to a remote resource 118 and to receive a data file or streaming data corresponding to the speech (corresponding to the prescription information 106) from the remote resource 118 for output as an audible message.

According to another embodiment, the prescription label 102 may include human-readable text corresponding to the prescription. The microprocessor circuit 108 may be configured to perform optical character recognition on the human-readable text to produce decoded data corresponding to the prescription, transmit the data corresponding to the prescription to a remote resource 118; and receive a data file or streaming data corresponding to the speech (corresponding to the prescription information 106) from the remote resource 118 for output as an audible message.

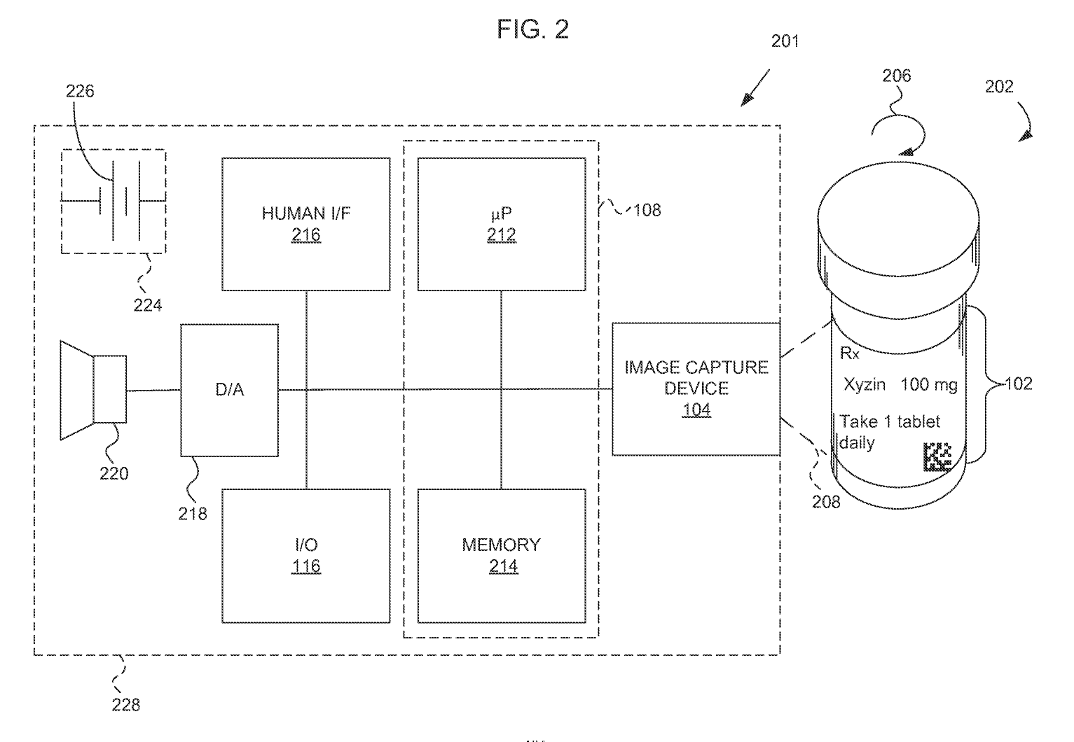

FIG. 2 is a block diagram of a system 201 for scanning a prescription label 102 on a prescription bottle 202, and providing an audio representation of at least portions of the prescription label 102 to a user (not shown), according to another embodiment.

Referring to FIG. 2, typically prescription bottles 202 are cylindrical (with draft), and prescription labels 102 are adhered to the cylindrical surface. Other prescription bottles 202 may be rectangular or have another shape, but typically prescription labels 102 are adhered to surfaces facing in different or continuously varying directions. In one embodiment, a person (not shown) manually rotates the prescription bottle 202, as indicated by the arrow 206, in a field of view 208 of an image capture device 104 such as a focal plane imager. The image capture device 104 may operate in a video mode. A microprocessor circuit 108 may include a microprocessor or microcontroller 212 and a memory 214 operatively coupled to the image capture device 104. The microprocessor circuit 108 may transfer video images to one or more computer memory and/or storage devices 214. As the prescription bottle 202 rotates all or most of the prescription label 102 is cached or saved to memory 214 as a series of overlapping images. The microcontroller 212 and memory 214 may cooperate according to computer readable instructions of a computer program retrieved from memory 214 to stitch together the best portions of each of the series of video images to make a two-dimensional (2D) image of the cylindrical surface. The stitched 2D image forms a bitmap from which further processing will proceed. Optionally a human interface 216 may include a button or trigger to receive a “capture label” command and/or may include a visible indicator of an estimated portion of the label 102 captured.

Optionally, other approaches may be used to capture an image of the prescription label 102. For example, (as indicated above) the prescription bottle 202 may be rotated by a mechanism rather than a human. Alternatively, the prescription bottle 202 may be held in a stage (not shown) configured to reflect, refract, or diffract image information from substantially all sides of the prescription bottle 202 onto a focal plane surface of the image capture device 104.

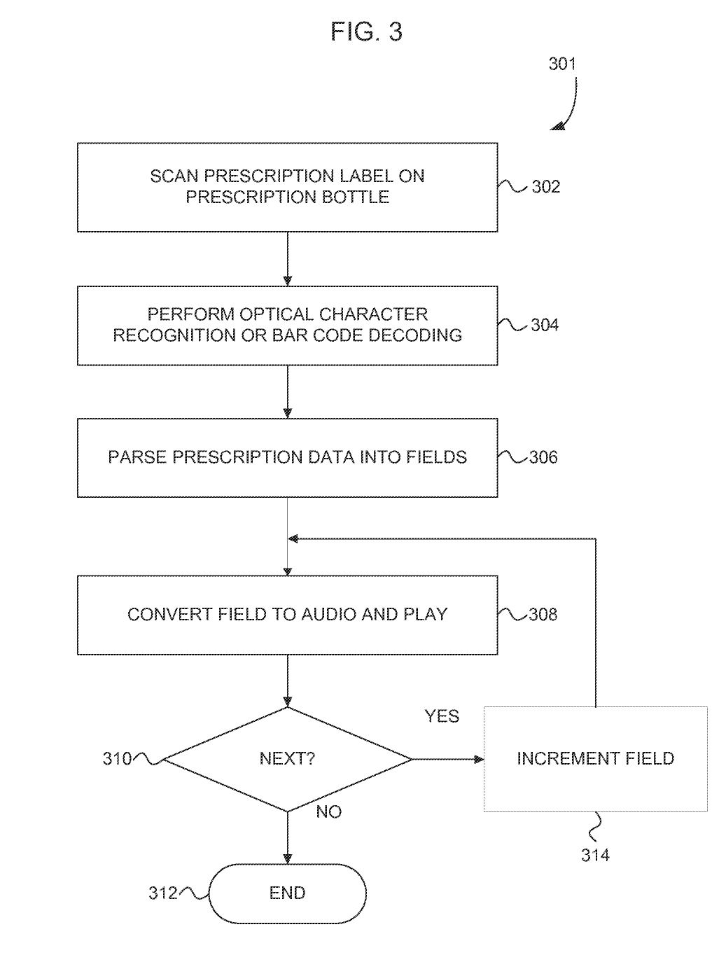

FIG. 3 is a flow chart showing a method 301 for presenting an audio representation of at least portions of a prescription label, according to an embodiment. Beginning at step 302, a prescription bottle is scanned to form an image, as described above. The process then proceeds to step 304. Optical character recognition (OCR) may be performed on the image of the prescription label created during step 302. The optical character recognition may be performed according to conventional techniques. Alternatively or additionally, the device 201 of FIG. 2 may hold in memory 214 one or more prescription label formats and/or one or more industry standard precaution symbols. Step 304 may include making a best match to a stored format and using font information and/or context-sensitive rules to perform the optical character recognition. Step 304 may save a prescription data file corresponding to the prescription label 102.

Proceeding to step 306, the prescription information may be parsed into fields. For example, the fields may be parsed into a predetermined order according to importance, convenience, or user preferences. For example, referring to the example prescription label 102 shown in FIG. 2, it may be seen that several fields are included (other fields referenced herein are omitted for clarity). In a real embodiment, the indicated fields and other fields may include an Rx prescription indicator, patient name (Doe, John), prescriber name (Dr. Spock), drug name (Xyzin), dosage (100 mg), instructions (take 1 tablet daily), number of refills left on the prescription (1 refill), and a precaution label (including a symbol and “Do not drink”). Step 306 may parse these fields into an order convenient to a user. For example, the system 201 may parse these fields into parsed messages that optionally include additional verbiage according to an order:

1. [Xyzin] [prescription] for [John Doe]

2. [Take one tablet daily]

3. Caution, [do not drink] alcoholic beverages when taking [Xyzin]

4. Dosage is [100 mg] per tablet

5. Prescribing authority is [Doctor Spock]

6. You have [one] available refill

In this example, field values are shown in brackets and additional verbiage is not bracketed.

Proceeding to step 308, the first field is converted into audio, and the audio is played. Referring to FIG. 2, the microcontroller 212 cooperates with the memory 214 according to computer readable instructions configured to convert the text into a synthesized or pre-recorded human voice. The prescription information may thus be converted into a series of audio files corresponding to each of the parsed fields. Referring to FIG. 3, upon finishing step 306, for example, the process 301 may immediately proceed to step 308 and output the first converted audio file through a digital-to-analog converter 218 (FIG. 2), an amplifier (not shown), and a speaker 220 (FIG. 2) to provide an audio message to the user, “Xyzin prescription for John Doe.” This message may serve to help a user in the dark or who has poor eyesight to quickly determine which prescription bottle he is holding. The process 301 then proceeds to step 310. Step 310 is essentially a wait state. If the user provides no additional input within a period of time, the process then proceeds to an end state 312. If the user requests additional information, such as by pressing a button 216 (FIG. 2), the process proceeds to step 314 where the prescription information field is incremented. The process 301 then loops to step 308 again, which would provide an audio message, “Take one tablet daily.” The loop 308, 310, 314 may be repeated as desired by the user to step through all the parsed messages.

As may be appreciated by inspection, each of the parsed messages 1-6 may variously have a 1:1 relationship to parsed fields, may include portions of parsed fields, and/or may include all or portions of a plurality of parsed fields. For example, the first illustrative parsed message includes three parsed fields plus inserted text. The second parsed message includes the entirety of one parsed field. The third parsed message includes mostly inserted verbiage and one parsed field.

Referring again to FIG. 2, the system 201 may be configured to operate stand-alone and/or may include a communication interface 116. The communication interface 116 may include, for example, a USB port, a Wi-Fi or WiMAX connection, a cell phone connection, or other interface configured for occasional or real-time access to a computer network such as the Internet. The system 201 may include a battery holder 224 and/or one or more batteries 226, and may include a housing 228 that may, for example, be configured for hand held use and/or for mounting in a convenient location, such as near or in a medicine cabinet.

Optionally, the system 201 may include a clock (not shown) and may be configured to determine an elapsed time since the most recent scan. For applications where the prescription bottle 202 and prescription label 102 are scanned before each dose, the system may compare the elapsed time to the instructions, and prompt the user that he has already taken his medicine, that it is about time for a dose, or that he may have missed a dose.

Optionally, the prescription label 102 may include, or an adjunct label may be provided that includes a bar code symbol 114 with encoded prescription information 106 fields and/or audio messages. For example, one such bar code symbology is referred to commercially as Sound Paper (TM) and is described in U.S. patent application Ser. No. 12/848,853, entitled, METHOD FOR REPRODUCING AND USING A BAR CODE SYMBOL, co-pending at the time of this filing; and in U.S. patent application Ser. No. 12/079,240, entitled METHOD AND APPARATUS FOR USING A LIMITED CAPACITY PORTABLE DATA CARRIER, co-pending at the time of this filing, both of which are incorporated by reference herein. In embodiments where such symbols are included, one or more of steps 304, 306, and the conversion portion of step 308 may be omitted from process 301 of FIG. 3, and audio messages from the symbol may be substituted for messages derived from the OCR parse convert process.

Optionally, the bar code symbol 114 with encoded prescription label data fields and/or audio messages may augment the prescription label 102. For example, the prescription label 102 may be processed as described above, and an audio file encoded in the bar code symbol 114 may include a personal message from a pharmacist or the prescribing authority. In this way, the user can be reminded of a conversation he had with his doctor or pharmacist and be aided in recalling any additional explanation that he had received when the prescription was made or filled.

Optionally, converting a prescription field to audio may include translating the prescription field from one language to a second language. Similarly, playing the audio file may include playing an audio file in the second translated language.

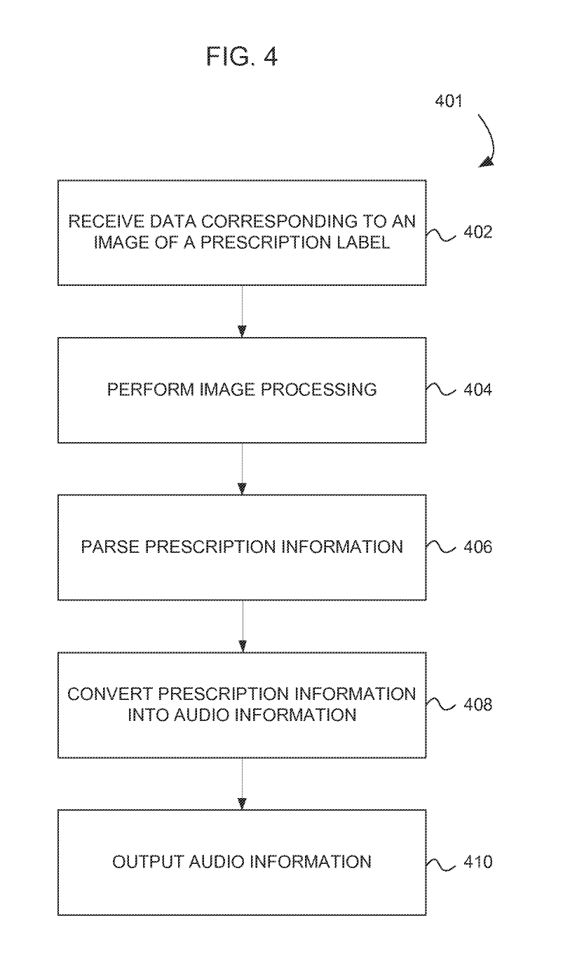

FIG. 4 is a flow chart showing a method 401 for providing audible prescription information to a user, according to an embodiment.

In the first step 402, data that corresponds to an image of a prescription label may be received. Receiving the data may include receiving a bitmapped image in a digital file and/or may include receiving a stream of image data from an image scanner, for example.

In step 404, the data received in step 402 may be processed to decode and/or extract features from the label image corresponding to the received data. Image processing of the received data may include extracting prescription information from the label image. The prescription information may include one or more data fields, which may include data items such as patient's name, prescribing doctor's name, name of medication, dosage, and so on.

Proceeding to optional step 406, the extracted data may be parsed. Examples of prescription information parsing are described above in conjunction with FIG. 3. The data fields may indicate prescription information items such as patient's name, prescriber's name, drug name, dosage, and so on. The parsing of step 406 may arrange the items of prescription information and/or the audio information into a predetermined order according to importance, convenience, or user preference.

In the subsequent step 408, at least one data field of the prescription information may be converted into corresponding audio information.

In step 410, the audio information may be output for playback to a user.

The method 401 may be performed entirely by an end device such as a stand-alone or client apparatus 112 shown in FIG. 1, may be performed entirely by a remote resource such as a server, as indicated by 118 in FIG. 1, or may be partly performed by an end device 112 and partly performed by a remote resource 118 such as a server.

For embodiments wherein at least a portion of the method 401 is performed by an end device, step 402 may include capturing the image of the prescription label. Capturing the image of the prescription label may include capturing video images or a sequence of still images of the prescription label while the user rotates a cylindrical prescription label, and stitching the video images or sequence of still images into a two-dimensional image of the cylindrical prescription label. Capturing the image of the prescription label may also include operating a mechanical or optical encoder to sense rotation corresponding to a cylindrical prescription label. Data from an encoder may be used to convert the cylindrical prescription label into a corresponding two-dimensional image.

In an embodiment wherein at least a portion of the method 401 is performed by a remote resource or server computer, step 402 may include receiving the data via a network interface from a client device. Similarly, step 410 may include transmitting the audio information via the network interface to the client device for playback to the user.

In some embodiments, the prescription label may include one or more bar code symbols that carry the prescription information. The image processing of step 404 may include decoding the prescription information from the one or more bar code symbols. The prescription information carried by the one or more bar code symbols may optionally include audio data. The audio data may include a plurality of speech segments and the bar code symbol may include a corresponding plurality of speech segment data fields. Performing image processing on the data corresponding to the image of the prescription label to produce prescription information may include separately decoding each speech segment data field and assembling a plurality of decoded speech segments into the audio data.

As used herein, the term “bar code” is not limited to conventional one-dimensional (1D) bar codes such as the common UPC code, but may also refer to two-dimensional (2D) codes such as PDF 417, Data Matrix, and/or QR code symbologies, or to another encoding system for representing digital data as an array of machine-readable graphic marks, symbols, or shapes in a defined area of the prescription label. In some embodiments, the bar code may include or consist of the “Soundpaper” symbology, available from Labels That Talk, Ltd. of Redmond, Wash. USA.

Decoding one or more bar code symbols may use one or more of several bar code decoding or image processing techniques. For example, this may include performing one or more computational methods, image processing, performing a Fourier transform, a phase mask, a chipping sequence, a chipping sequence along an axis, pattern matching in the image domain, pattern matching in the frequency domain, finding bright spots in the frequency domain, synthesizing data from a neighboring data segment, pseudo-decoding data from a neighboring data segment, a finder pattern, finding parallel edges, finding a finder pattern, centers decoding, image resolution using a priori knowledge of symbol structure, closure decoding, edge finding, uniform acceleration compensation, surface de-warping, anti-aliasing, frame transformation, frame rotation, frame de-skewing, keystone correction, Gray Code, pattern phase, phase comparison, delta distance, local thresholding, global thresholding, modulation compensation, image inversion, inverted image projection, and sampling image regions positioned relative to a finder.

Additionally or alternatively, step 404 of FIG. 4 may include performing optical character recognition (OCR) on the captured image of the prescription label to produce at least some of the prescription information.

Performing image processing on the data corresponding to the image of the prescription label to produce prescription information including one or more fields in step 404 may optionally include or consist essentially of decoding a bar code symbol carrying audio data corresponding to the prescription information.

In step 408, converting at least one field of prescription information into corresponding audio information may include synthesizing speech corresponding to the prescription, which may include decoding the label image into text, and converting the text to speech. Converting at least one field of prescription information into corresponding audio may additionally include playing back a recorded message corresponding to the prescription.

In some embodiments, different prescription label formats may be encountered. Some labels may contain only textual information, readable with OCR processing. Other labels may additionally include a prescription identifier encoded in a bar code. Alternatively or additionally, some labels may include prescription information encoded in one or more bar codes. Alternatively or additionally, some labels may include audio or speech information encoded in a machine-readable format such as a bar code.

To provide optimal handling of multiple label formats, a heuristic is contemplated for converting prescription information into audio information, which may, for example, be implemented in steps 404 through 408. One illustrative heuristic may include:

If the prescription label contains a bar code symbol carrying audio or speech data, decoding the audio or speech data and playing it back to the user. The process may then proceed to an end state. Otherwise, if the prescription label contains a symbol or bar code carrying prescription information, then the method 401 may include parsing the prescription information, converting it to a speech message, and playing the message back to the user. If the prescription label contains a symbol or bar code carrying a prescription identifier, then the method 401 may include transmitting the identifier to a remote resource and receiving the prescription information from the remote resource, parsing the prescription information, converting it to a speech message, and playing the message back to the user. If the prescription label does not carry a bar code symbol, or if the bar code symbol does not carry or link to all the prescription information desired, the method 401 may include performing OCR on the prescription label, extracting the prescription information from the recognized text, converting the prescription information to a speech message, and playing the message back to the user.

It may be appreciated that other heuristics are possible and fall within the scope and meaning of the specification and appended claims. For example, the method 401 may include generating the speech message from a plurality of data sources. For example, a data source may include a clock, and the speech message may include a reminder for the user to take his or her medication, or may include a warning that it is too soon for the user to take his or her medication. The multiple sources may include audio data, prescription information, textual data from the prescription label, and/or information received from a remote resource in response to providing a prescription identifier decoded from the prescription label.

Step 410 may include playing the audio information to a user, and/or may include transmitting the audio information to a client device via a network interface.

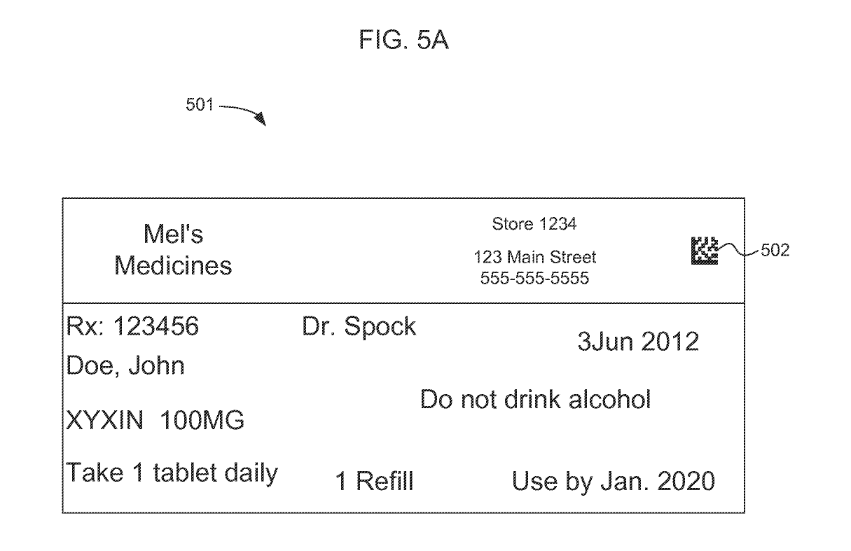

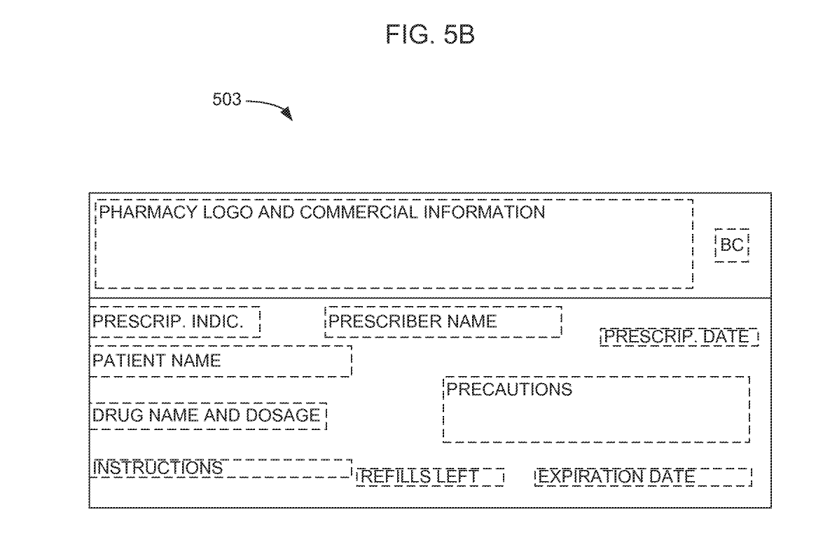

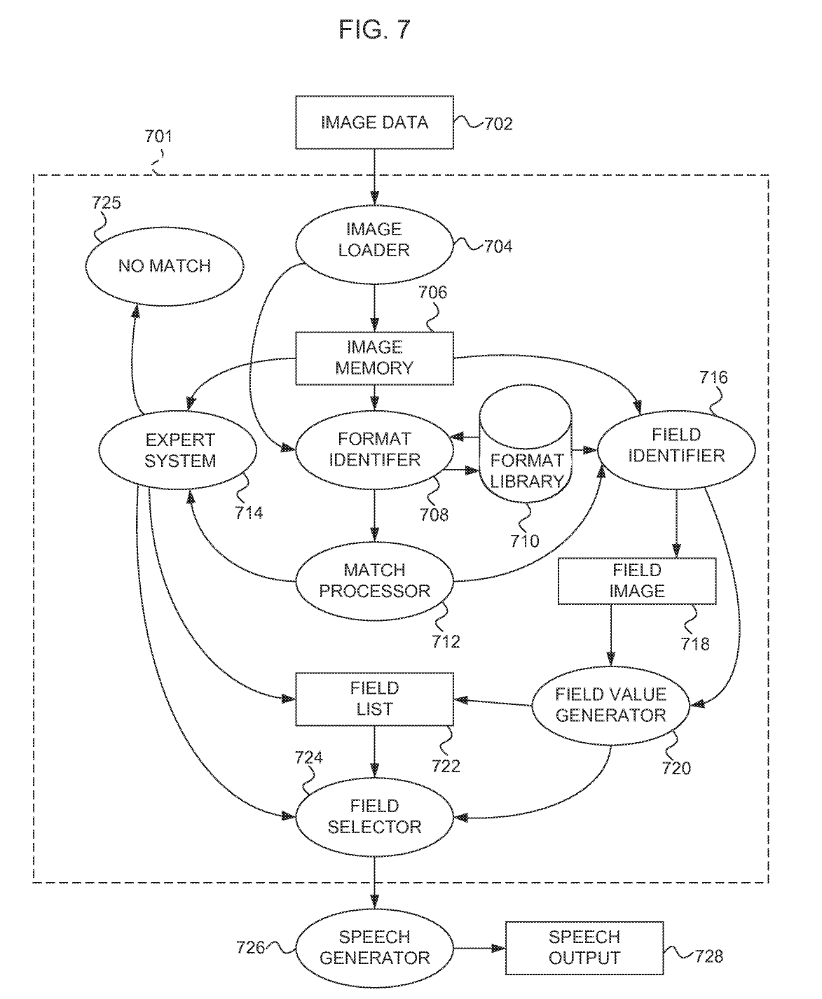

FIG. 5A is a diagram of an illustrative prescription label 501, according to an embodiment. As may be appreciated, prescription labels of many different formats are in use. The prescription label 501 represents an instance of a label printed according to a format corresponding to the format 503 shown in FIG. 5B. The prescription label 501 may include a format identification bar code symbol 502. The format identification bar code symbol 502 may provide a record identification corresponding to a linking field in a record of the format library 710 described in conjunction with FIG. 7.

FIG. 5B is a graphical diagram of an illustrative label format 503, corresponding to the illustrative prescription label instance of FIG. 5A. FIG. 5B shows a graphical depiction of format element locations as dashed outlines. The name of the respective format elements may be as indicated by the words inside the dashed outlines or by other more compact variable names. The x,y coordinates of the indicated format elements may be stored as field values in a particular record of the format library 710 (described in conjunction with FIG. 7) for the particular format 503.

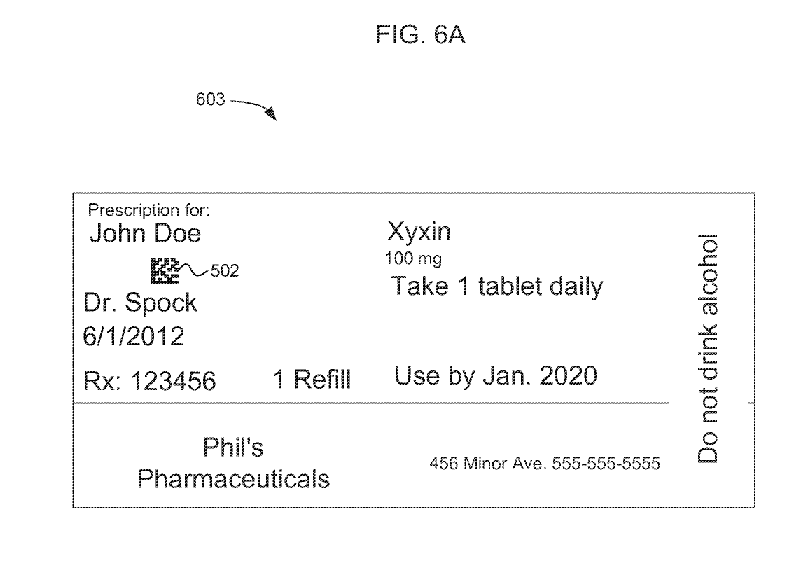

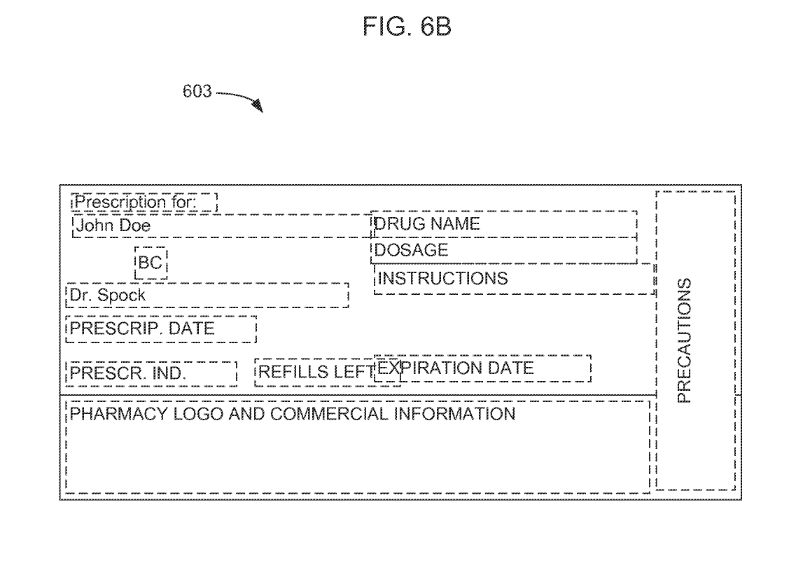

FIG. 6A is a diagram of another illustrative prescription label 601, according to another embodiment. As may be appreciated by inspection, many of the data fields present in format 501 and 601 may be in common, but rearranged on the label. Moreover, some fields of information (such as generic warnings, advertising information, pharmacy logo, etc.) may be different or missing on one or the other of the label formats 501, 601. FIG. 6A represents an instance of a label printed according to a format 603 shown in FIG. 6B.

FIG. 6B is a graphical diagram of an illustrative label format 603, corresponding to the illustrative prescription label instance 601 of FIG. 6A. FIG. 6B shows a graphical depiction of format element locations as dashed outlines. The names of the respective format elements may be as indicated by the words inside the dashed outlines or by other more compact variable names. The x,y coordinates of the indicated format elements may be stored as field values in a particular record of the format library 710 corresponding to the format 603.

The consistency of prescription information, along with a finite universe of commonly encountered prescription labels may be used to extract and parse the prescription information from various prescription labels.

FIG. 7 is a state diagram showing a process 701 for extracting and parsing prescription information from a prescription label, and the relationship of the process to generating speech corresponding to the parsed prescription information, according to an embodiment. As described above, the process 701 may be performed by a client or user device, a server, or a combination of a client and server. In some embodiments, the process 701 may comprehend steps 304, 306, 308, 310, and 314 (FIG. 3) and/or steps 404 and 406 (FIG. 4). It may be understood that the processes illustrated in FIG. 7 may be partitioned differently without departing from the scope and spirit of the invention. It may be understood that the processes illustrated in FIG. 7 may be augmented by other known processes and/or may contain known processes for performing the indicated functions. It may also be understood that transfer of control from one process to the next may be indicative of a return to and a subsequent call from a supervisory process.

Image data 702 may be received by an image loader module 704. The image loader module 704 may operate responsive to a “shutter button” actuation on a client or user device, or may operate responsive to image data 702 received via a web interface, for example. The image loader module 704 loads an image of a prescription label into image memory 706. Optionally, the image loader module 704 may stitch together a sequence of video frames or still images corresponding to a cylindrical prescription label. Additionally or alternatively, the image loader module 704 may cooperate with an encoder (not shown), with an optical cylindrical scanner (not shown), and/or with a label rotator (not shown) to capture an image of a cylindrical prescription label. Alternatively, the image loader module 704 may interact with a blister pack imager (not shown) configured to capture images of prescription information on a unit dose or multiple unit dose blister pack. The image loader module 704 may further provide deskewing, keystone correction, gamma correction, and/or image scaling such as stretching, and/or compression to normalize the prescription label image written to image memory 706. The prescription label image in image memory 706 may be assumed to be a two dimensional image or a flattened version of a prescription label imaged from a non-flat surface.

After loading the prescription label image into the image memory 706, the image loader module 704 passes control to a format identifier module 708. The format identifier module 708 may compare the prescription label image in image memory to each of a plurality of prescription label formats held in a format library 710. For example, the format identifier module 708 may sequentially retrieve prescription label formats from the format library 710 and compare them to the prescription label image in the image memory 706. The format identifier module 708 may preprocess the prescription label image in image memory 706 to create a field map. Alternatively, the format identifier module 708 may compare the actual prescription label image in the image memory 706 to each corresponding prescription label format in the format library 710. The format identifier 708 may perform a comparison of the prescription label image to each prescription label format by attempting to adjust registration of the images to a best fit registration, perform additional stretching or compression, and/or perform additional image normalization. The format identifier module 708 may then determine how well the registered fields in the prescription label format compare to corresponding pixel data in the prescription label image. Fixed data (including white space) in the format may be carried as an actual data image, and may be especially useful for determining best registration. Variable data in the format may be carried as an “unknown” value that neither penalizes nor rewards a comparison with pixel values from the prescription label image. One example of goodness of fit may include a count of pixel values that do not match between a prescription label image and a prescription label format. A low count of pixel non-matches may indicate a good fit.

The format identifier module 708 may maintain a running measure of goodness of fit for each compared prescription label format and/or may maintain a smaller number of the best (or first and second, etc.) fit match. After identifying the best fit prescription label format from the format library 710, the format identifier module 708 passes control to a match processor module 712.

The match processor module 712 may compare a goodness-of-fit criterion generated by the format identifier 708 to determine if there is a sufficiently high correlation between the prescription label image and the best match prescription label format. For matches that are not sufficiently high certainty, the match processor module 712 may transfer control to an expert system module 714. The expert system module 714 is described more fully below. For matches that are sufficiently high certainty, the match processor 712 may transfer control to a field identifier module 716.

Optionally, the format identifier 708 may include a bar code decoder. For example, the bar code decoder may include a finder module configured to identify possible instances of bar code finder patterns, and one or more bar code decode algorithm(s) selected to decode bar code symbol(s) embedded in the image of the prescription label. The format identifier 708 may include logic to first select a format from the format library 710 corresponding to a format identification decoded from the embedded bar code symbol(s), such as a symbol 502 shown in FIGS. 5A and 6A. Optionally, further analysis to determine a goodness-of-fit may be omitted and the format identity may be pipelined through or past the match processor 712 to the field identifier module 716.

The field identifier module 716 may use information in the selected format library record (the record corresponding to the best fit format) to extract one or more field images from the image memory 706. The format library 710 may include a database of prescription label formats and prescription data field locations, for example. Optionally, the format library 710 may include other attributes of each prescription label format such as, for example, a uniform resource locator (URL) or other communication coordinate for corresponding pre-recorded speech data, font information, and/or other information that may be used to aid in extracting or obtaining prescription information based on a corresponding prescription label image.

The format library may include an indication of an x,y location range for a patient name, an indication of x,y location range of the medicine name, an indication of x,y location range of a dosage identifier, etc.

The field identifier module 716 may copy the indicated location ranges from the image memory, and load the images into a field image memory 718. The field image memory 718 may include tag data indicating the type of field, and a bitmap or vector image of the corresponding field extracted from the image memory 706. Additionally or alternatively, the field identifier module 716 may write prescription label attributes from the format library 710 into the field image memory 718 (or alternatively may write a pointer to a corresponding format library 710 location). After loading all the field images and/or attributes into the field image memory 718, the field identifier module 716 may pass control to a field value generator module 720.

The field value generator module 720 may perform optical character recognition on each field image in the field image memory 718, and load corresponding ASCII or Unicode characters, along with the corresponding field tag data into a field list memory 722. Additionally or alternatively, the field value generator 720 may use format attributes loaded into the field image memory 718 to populate data into the field list memory 722. For example, a format attribute corresponding to a URL may be used by the field value generator module 720 to access the URL, download corresponding information, and load the corresponding information in the field list memory 722. In the case of a voice recording, for example, the field value generator module 720 may download the recording as a binary large object (BLOB) and load the BLOB into the field list memory 722. After performing optical character recognition on the fields in the field image memory 718, the field value generator module 720 may pass control to a field selector module 724.

As indicated above, some (assumed) prescription label images stored in the image memory 706 may not be matched by the format identifier module 708 to a prescription label format from the format library 710 with sufficient certainty or goodness-of-fit for the match processor module 712 to pass control to the field identifier module 716. Such images are considered to be unmatched. The image may be a prescription label image whose format is not (yet) in the format library, or the image may not be a prescription label at all. In such cases, the match processor module 712 may pass control to an expert system module 714.

The expert system module 714 may operate as an optical character recognition (OCR) module combined with a field data analyzer module. For example, the expert system module 714 may attempt to perform OCR on the image in the image memory 706. Data that is converted to characters may then be analyzed to determine if it likely corresponds to prescription information or if it likely does not correspond to prescription information. For example, “Rx:” followed by a numeric or alphanumeric string may be interpreted by the expert system module 714 to be a prescription number. Similarly an alpha string followed by “#MG” (where # is a number) may be assumed to correspond to the name of a medication and a unit size in milligrams. The expert system module 714 may then search its database (not shown) and/or access a remote resource to attempt to match the alpha string to a name of a medication. A decoded OCR field “Take 1 tablet daily” may be matched to a database of dosage instructions to correlate the OCR field to an Instruction Field.

If the expert system module 714 is unable to deduce or infer prescription information from the image in the image memory 706, the image may be considered unmatched, and the expert system module 714 may pass control to a no match module 725. If the expert system module 714 is able to correlate image information from the image memory 706 to prescription information, then the expert system module 714 may load the field list memory 722 with the decoded prescription information, and then pass control to the field selector module 724.

The field selector module 724 may act as a message assembler and prioritizing agent. The field selector module 724 may read field data (e.g., prescription information fields) from the field list memory 722 and output corresponding data (e.g., text) to a speech generator 726. As described above, for example, the field selector module 724 may parse fields from the field list memory 722 into parsed messages that optionally include additional verbiage according to a priority order:

1. [Xyzin] [prescription] for [John Doe]

2. [Take one tablet daily] . . .

Optionally, the field selector module 724 may receive input from a human interface to output a field, proceed to the next field, repeat a field, or end the process.

The speech generator module 726 may receive each field from the field selector module 724 and convert each field to speech. As described above, the speech generator module 726 may assign phonetic transcriptions to each word, and divide and mark the text into prosodic units, like phrases, clauses, and sentences. Alternatively, the field selector module 724 may perform this portion of front-end speech processing. The speech generator module 726 may assign phonetic transcriptions to words according to text-to-phoneme or grapheme-to-phoneme conversion. Phonetic transcriptions and prosody information together make up a symbolic linguistic representation. The speech generator module 726 may then perform speech synthesis, wherein the symbolic linguistic representation is converted into sound. In some embodiments, converting the symbolic linguistic representation to sound may include computing of a target prosody (pitch contour, phoneme durations), which may be imposed on the output speech. The speech generator outputs speech data 728, which may be in the form of streaming data or an audio data file.

Optionally all or portions of the methods illustrated by flow charts herein may be embodied as computer-executable instructions carried by a non-transitory computer-readable medium or media.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A system for reading prescription labels, comprising:
an image capture device configured to capture an image of a prescription label carrying prescription information;
a microprocessor circuit operatively coupled to the image capture device and configured to process data corresponding to the image, cause transmission of data corresponding to the image, or process the data corresponding to the image and cause transmission of the data corresponding to the image to convert the image into speech corresponding to the prescription information; and
an audio output device operatively coupled to the microprocessor circuit and configured to output the speech corresponding to the prescription information to a user as an audible message.

2. The system for reading prescription labels of claim 1, wherein the image capture device, the microprocessor circuit, and the audio output device comprise respective portions of a smart phone, tablet computer, portable computer, or desktop computer.

3. The system for reading prescription labels of claim 1, wherein the microprocessor circuit is configured to run a software application including computer executable instructions for processing the image or causing transmission of the data corresponding to the image to convert the image into speech corresponding to the prescription information.

4. The system for reading prescription labels of claim 1, wherein the microprocessor circuit is configured to receive video images or a sequence of still images of the prescription label while the user rotates a cylindrical prescription label, and to stitch the video images or sequence of still images into a two-dimensional image of the cylindrical prescription label.

5. The system for reading prescription labels of claim 1, further comprising:
a mechanical or optical encoder configured to sense rotation corresponding to a cylindrical prescription label;
wherein processing the image includes converting the cylindrical prescription label image into a corresponding two-dimensional image responsive to data from the mechanical or optical encoder.

6. The system for reading prescription labels of claim 1, wherein converting the image into speech corresponding to the prescription information includes synthesizing the speech corresponding to the prescription information.

7. The system for reading prescription labels of claim 1, wherein converting the image into speech corresponding to the prescription information includes:
decoding the image into text; and
converting the text to speech.

8. The system for reading prescription labels of claim 1, wherein converting the image into speech corresponding to the prescription includes playing back a recorded message corresponding to the prescription information.

9. The system for reading prescription labels of claim 1, wherein the prescription label includes a bar code symbol carrying encoded data corresponding to the speech corresponding to the prescription information; and
wherein the microprocessor circuit is configured to decode the bar code symbol to convert the data to the speech corresponding to the prescription information.

10. The system for reading prescription labels of claim 9, wherein the bar code symbol includes a two-dimensional (2D) matrix symbol.

11. The system for reading prescription labels of claim 9, wherein the encoded data includes a plurality of speech segments and the bar code symbol includes a corresponding plurality of speech segment data fields; and
wherein the microprocessor circuit is further configured to separately decode each speech segment data field and to assemble a plurality of decoded speech segments into the decoded data.

12. The system for reading prescription labels of claim 1, wherein the prescription label includes a bar code symbol carrying encoded data corresponding to prescription information; and
wherein the microprocessor circuit is configured to decode the bar code symbol, parse decoded prescription information into one or more data messages, convert the one or more data messages into one or more speech messages, and assemble the one or more speech messages into the speech corresponding to the prescription information.

13. The system for reading prescription labels of claim 12, wherein parsing the prescription information into one or more data messages includes parsing the prescription information into a predetermined order according to importance, convenience, or user preferences.

14. The system for reading prescription labels of claim 1, wherein the prescription label includes human-readable text corresponding to prescription information; and
wherein the microprocessor circuit is configured to perform optical character recognition on the human-readable text to decode the prescription information, parse the prescription information into one or more data messages, convert the one or more data messages into one or more speech messages, and assemble the one or more speech messages into the speech corresponding to the prescription information.

15. The system for reading prescription labels of claim 14, wherein parsing the prescription information into one or more data messages includes parsing the prescription information into a predetermined order according to importance, convenience, or user preferences

16. The system for reading prescription labels of claim 1, further comprising: a communication interface operatively coupled to the microprocessor circuit.

17. The system for reading prescription labels of claim 16, wherein the microprocessor circuit is configured to cause transmission of the image from the communication interface to a remote resource and to receive a data file or streaming data from the remote resource corresponding to the speech corresponding to the prescription information for output as the audible message.

18. The system for reading prescription labels of claim 16, wherein the microprocessor circuit is configured to decode the image, cause transmission of decoded data corresponding to the image from the communication interface to a remote resource, and to receive a data file or streaming data from the remote resource corresponding to the speech corresponding to the prescription information for output as the audible message.

19. The system for reading prescription labels of claim 16, wherein the prescription label includes a bar code symbol carrying an identifier corresponding to the prescription information; and
wherein the microprocessor circuit is configured to cause transmission of the identifier to a remote resource, to receive data from the remote resource corresponding to the prescription information, and to convert the data corresponding to the prescription information into the speech corresponding to the prescription information for output as the audible message.

20. The system for reading prescription labels of claim 16, wherein the prescription label includes a bar code symbol carrying an identifier corresponding to the prescription information; and
wherein the microprocessor circuit is configured to cause transmission of the identifier to a remote resource and to receive a data file or streaming data corresponding to the speech corresponding to the prescription information from the remote resource.

21. The system for reading prescription labels of claim 16, wherein the prescription label includes human-readable text corresponding to the prescription information; and
wherein the microprocessor circuit is configured to perform optical character recognition on the human-readable text to produce decoded data corresponding to the prescription information, transmit the data corresponding to the prescription information to a remote resource; and receive a data file or streaming data corresponding to the speech corresponding to the prescription information from the remote resource.

22. A method for providing prescription information to a user, comprising:
receiving data corresponding to an image of a prescription label;
performing image processing on the data corresponding to the image of the prescription label to produce prescription information including one or more fields;
converting at least one field of prescription information into corresponding audio information; and
outputting the audio information for playback to a user.

23. The method for providing prescription information to a user of claim 22, wherein receiving data corresponding to an image of a prescription label includes capturing the image of the prescription label.

24. The method for providing prescription information to a user of claim 23, wherein capturing the image of the prescription label further comprises:
capturing video images or a sequence of still images of the prescription label while the user rotates a cylindrical prescription label; and
stitching the video images or sequence of still images into a two-dimensional image of the cylindrical prescription label.

25. The method for providing prescription information to a user of claim 23, wherein capturing the image of the prescription label further comprises:
operating a mechanical or optical encoder configured to sense rotation corresponding to a cylindrical prescription label; and
converting the cylindrical prescription label into a corresponding two-dimensional image.

26. The method for providing prescription information to a user of claim 22, wherein the steps of receiving data, performing image processing, converting at least one field of prescription information into corresponding audio information, and outputting the audio information for playback to a user are performed by a client apparatus or a stand-alone apparatus.

27. The method for providing prescription information to a user of claim 22, wherein receiving data corresponding to an image of a prescription label includes receiving the data via a network interface from a client device.

28. The method for providing prescription information to a user of claim 22, wherein the steps of receiving data, performing image processing, converting at least one field of prescription information into corresponding audio information, and outputting the audio information for playback to a user are performed by a network resource operatively coupled to a client apparatus.

29. The method for providing prescription information to a user of claim 22, wherein performing image processing includes decoding one or more bar code symbols carrying the prescription information.

30. The method for providing prescription information to a user of claim 22, wherein performing image processing includes decoding one or more bar code symbols carrying the prescription information in the form of the audio information.

31. The method for providing prescription information to a user of claim 22, wherein performing image processing on the data corresponding to the image of the prescription label comprises:
performing optical character recognition on the captured image of the prescription label to produce the prescription information.

32. The method for providing prescription information to a user of claim 22, further comprising:
parsing the prescription information or audio information corresponding to the prescription information into the one or more fields.

33. The method for providing prescription information to a user of claim 32, wherein parsing the prescription information or audio information corresponding to the prescription information into one or more fields includes parsing the prescription information or audio information into a predetermined order according to importance, convenience, or user preferences.

34. The method for providing prescription information to a user of claim 22, wherein converting at least one field of prescription information into corresponding audio information includes synthesizing speech corresponding to the prescription.

35. The method for providing prescription information to a user of claim 22, wherein converting at least one field of prescription information into corresponding audio information further comprises:
decoding the image into text; and
converting the text to speech.

36. The method for providing prescription information to a user of claim 22, wherein converting at least one field of prescription information into corresponding audio includes playing back a recorded message corresponding to the prescription.

37. The method for providing prescription information to a user of claim 22, wherein performing image processing on the data corresponding to the image of the prescription label to produce prescription information including one or more fields includes decoding a bar code symbol carrying audio data corresponding to the prescription information.

38. The method for providing prescription information to a user of claim 37, wherein the audio data includes a plurality of speech segments and the bar code symbol includes a corresponding plurality of speech segment data fields; and
wherein performing image processing on the data corresponding to the image of the prescription label to produce prescription information includes separately decoding each speech segment data field and assembling a plurality of decoded speech segments into the audio data.

39. The method for providing prescription information to a user of claim 22, wherein outputting the audio information for playback to a user includes playing the audio information to a user.

40. The method for providing prescription information to a user of claim 22, wherein outputting the audio information for playback to a user includes transmitting the audio information to a client device via a network interface.

41. A non-transitory computer-readable medium carrying computer-executable instructions configured to cause a computer or electronic device to execute the steps comprising:
receiving data corresponding to an image of a prescription label;
performing image processing on the data corresponding to the image of the prescription label to produce prescription information including one or more fields;
converting at least one field of prescription information into corresponding audio information; and
outputting the audio information for playback to a user.

42. The non-transitory computer-readable medium of claim 41, wherein receiving data corresponding to an image of a prescription label includes capturing the image of the prescription label.

43. The non-transitory computer-readable medium of claim 42, wherein capturing the image of the prescription label further comprises:
capturing video images or a sequence of still images of the prescription label while the user rotates a cylindrical prescription label; and
stitching the video images or sequence of still images into a two-dimensional image of the cylindrical prescription label.

44. The non-transitory computer-readable medium of claim 42, wherein capturing the image of the prescription label further comprises:
operating a mechanical or optical encoder configured to sense rotation corresponding to a cylindrical prescription label; and
converting the cylindrical prescription label into a corresponding two-dimensional image.

45. The non-transitory computer-readable medium of claim 41, wherein the computer-executable instructions are configured to cause a client apparatus or a stand-alone apparatus to perform the steps of receiving data, performing image processing, converting at least one field of prescription information into corresponding audio information, and outputting the audio information for playback to a user.

46. The non-transitory computer-readable medium of claim 41, wherein receiving data corresponding to an image of a prescription label includes receiving the data via a network interface from a client device.

47. The non-transitory computer-readable medium of claim 41, wherein the steps of receiving data, performing image processing, converting at least one field of prescription information into corresponding audio information, and outputting the audio information for playback to a user are performed by a network resource operatively coupled to a client apparatus.

48. The non-transitory computer-readable medium of claim 41, wherein performing image processing includes decoding one or more bar code symbols carrying the prescription information.

49. The non-transitory computer-readable medium of claim 41, wherein performing image processing includes decoding one or more bar code symbols carrying the prescription information in the form of the audio information.

50. The non-transitory computer-readable medium of claim 41, wherein performing image processing on the data corresponding to the image of the prescription label comprises:
performing optical character recognition on the captured image of the prescription label to produce the prescription information.

51. The non-transitory computer-readable medium of claim 41, wherein the computer executable instructions are further configured to cause a computer or electronic device to perform the step comprising:
parsing the prescription information or audio information corresponding to the prescription information into the one or more fields.

52. The non-transitory computer-readable medium of claim 51, wherein parsing the prescription information or audio information corresponding to the prescription information into one or more fields includes parsing the prescription information or audio information into a predetermined order according to importance, convenience, or user preferences

53. The non-transitory computer-readable medium of claim 41, wherein converting at least one field of prescription information into corresponding audio information includes synthesizing speech corresponding to the prescription.

54. The non-transitory computer-readable medium of claim 41, wherein converting at least one field of prescription information into corresponding audio information further comprises:
decoding the image into text; and
converting the text to speech.

55. The non-transitory computer-readable medium of claim 41, wherein converting at least one field of prescription information into corresponding audio includes playing back a recorded message corresponding to the prescription.

56. The non-transitory computer-readable medium of claim 41, wherein performing image processing on the data corresponding to the image of the prescription label to produce prescription information including one or more fields includes decoding a bar code symbol carrying audio data corresponding to the prescription information.

57. The non-transitory computer-readable medium of claim 56, wherein the audio data includes a plurality of speech segments and the bar code symbol includes a corresponding plurality of speech segment data fields; and
wherein performing image processing on the data corresponding to the image of the prescription label to produce prescription information includes separately decoding each speech segment data field and assembling a plurality of decoded speech segments into the audio data.

58. The non-transitory computer-readable medium of claim 41, wherein outputting the audio information for playback to a user includes playing the audio information to a user.

59. The non-transitory computer-readable medium of claim 41, wherein outputting the audio information for playback to a user includes transmitting the audio information to a client device via a network interface.

60. A method for providing prescription information, comprising:
capturing an image of a prescription label;
performing optical character recognition on the captured image of the prescription label to produce prescription information;
parsing prescription information into one or more fields;
converting at least one field of prescription information into corresponding audio information; and
playing the audio information to a user.

61. A system for reading prescription labels, comprising:
an image capture device configured to capture the image of a prescription label;
a microprocessor operatively coupled to the image capture device;
a computer memory operatively coupled to the image capture device and the microprocessor; and
an audio output device operatively coupled to the microprocessor and computer memory;
wherein the microprocessor and computer memory are configured to cooperate to convert the image of the prescription label to prescription information, parse the prescription information into fields, convert one or more fields into an audio file, and cause the audio file to be output as an audible signal to a user.

62. A prescription label, comprising:
a plurality of prescription information fields printed on the prescription label according to particular format; and
a bar code symbol printed on the prescription label, the bar code symbol carrying information indicating the particular format.
